(19) United States
(12) Patent Application Publication
(10) Pub. No.: US 2009/0091921 A1
(43) Pub. Date: Apr. 9, 2009

(54) Decorative object connectable to a connected object

(76) Inventor: Jung-Chou Yang, Taiping City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/905,875

(22) Filed: Oct. 5, 2007

(51) Int. Cl. F21V 21/08

(52) U.S. Cl. 362/103

(57) ABSTRACT

In a decorative object connectable to a connected object, a connecting member includes a fixing portion at an end of the connecting member, and the fixing portion is connected and fixed to a stylish decorative object with a specific shape, and another end of the connecting member is a stop portion, and a connecting portion is disposed between both ends, and a stop portion of the connecting member is passed through a connecting hole of the connected object, and stopped by both ends and positioned onto the connected object, and the stylish decorative object includes a light emitting element.

### BACKGROUND OF THE INVENTION

1. Field of the Invention

The present invention relates to a decorative object connectable to a connected object, and more particularly to a decorative object that can be installed and removed at the connected object.

2. Description of the Related Art

In general, a traditional decorative object installed on a connected object such as a shoe, a hat, a backpack, or a cloth is fixed. Although these decorative objects can provide the decorating effect, they also have the following problems:

1. The decorative object cannot be replaced. Most of the traditional decorative objects installed on a connected object are fixed, and thus they cannot be replaced. For users who want to have new configurations from time to time, the decorative object cannot meet the requirement for such a change of connected object.

2. The decorative object does not provide any warning. In general, the decorative object installed on a connected object is used for decoration only, and usually does not have any lighting effect, and thus the decorative objects of this sort will not provide any warning when users are walking at nighttime.

3. The decorative object does not have much fun. Since the traditional decorative object cannot be replaced, and does not come with a lighting effect, therefore its use is relatively monotonous.

### SUMMARY OF THE INVENTION

It is a primary objective of the present invention to overcome the aforementioned shortcoming by connecting a stylish decorative object and a connecting member, wherein the connecting member is designed to facilitate the installation and removal of the decorative object on the connected object, so that the stylish decorative object can be installed easily onto the connected object for the decoration purpose, and the connected object can be removed and replaced by a different stylish decorative object.

Another objective of the present invention is to install a light emitting device inside the stylish decorative object, not only improving the decoration effect of the stylish decorative object, but also providing a warning effect for users to walk at nighttime.

To achieve the foregoing objectives, the present invention provide a decorative object comprising: a connecting member having a fixing portion disposed at an end of the connecting member and connected and fixed to a stylish decorative object in a specific shape; a stop portion disposed at another end of the connecting member; a connecting portion disposed between both ends of the connecting member; a stop portion of the connecting member being passed through a connecting hole of the connected object, and stopped by both ends and positioned onto the connected object; and a light emitting element of a light emitting device disposed inside the stylish decorative object.

### BRIEF DESCRIPTION OF THE DRAWINGS

FIG. 1 is a perspective view of the present invention;

FIG. 2 is an exploded view of the present invention;

FIG. is a sectional view of the present invention;

FIG. 4 is a perspective view of another stylish decorative object of the present invention;

FIG. 5 is a schematic of a decorative object combined with a shoe in accordance with the present invention;

FIG. 6 is a schematic view of emitting light after a decorative object is shaken in accordance with the present invention;

FIG. 7 is a schematic view of a decorative object combined with a backpack in accordance with the present invention;

FIG. 8 is a schematic view of a decorative object combined with a hat in accordance with the present invention;

FIG. 9 is an exploded view of a second preferred embodiment of the present invention;

FIG. 10 is a sectional view of a second preferred embodiment of the present invention;

FIG. 11 is sectional view of a third preferred embodiment of the present invention; and

FIG. 12 is a sectional view of a fourth preferred embodiment of the present invention.

### DETAILED DESCRIPTION OF THE PREFERRED EMBODIMENTS

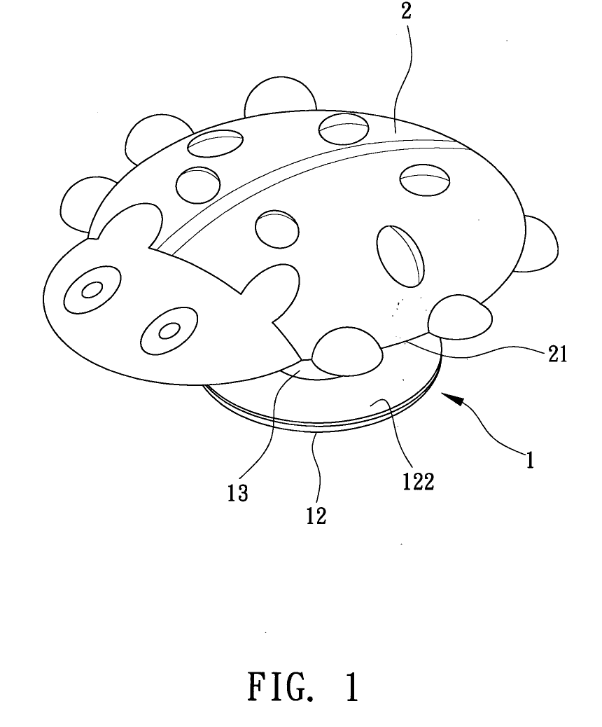

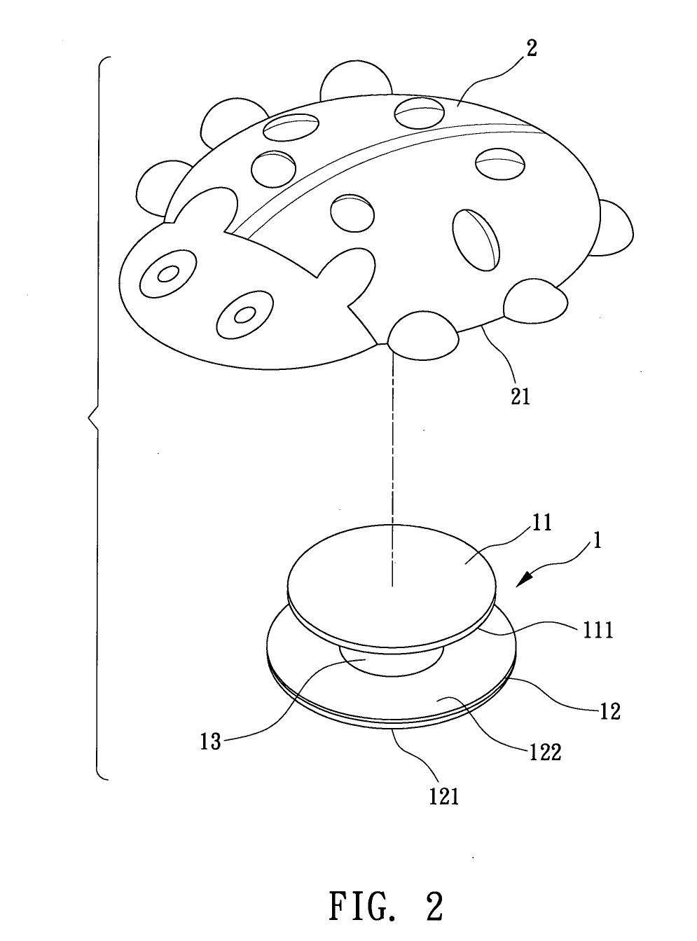

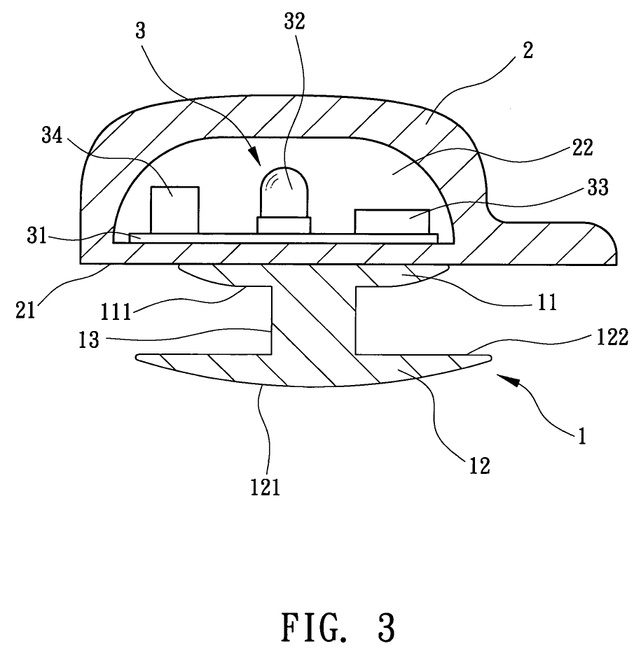

Referring to FIGS. 1 to 4 for an assembly of a decorative object in accordance with a preferred embodiment of the present invention, the embodiment is provided for illustration purpose only, and such structure is not intended to limit the scope of the present invention.

This embodiment provides a decorative object connectable to a connected object, comprising a connecting member 1 connectable to a connected object, a stylish decorative object 2 fixed to an end of the connecting member, and a light emitting device 3 installed inside the stylish decorative object 2.

The connecting member 1 includes a fixing portion 11 at an end of the connecting member 1, and a stop portion 12 at another end of the connecting member 1 and corresponding to the fixing portion 11, and the connecting member 1 includes a connecting portion 13 disposed between the fixing portion 11 and the stop portion 12, and the external diameter of the connecting portion 13 is smaller than the external diameter of the fixing portion 11 and the stop portion 12, for forming a first stop surface 111 at a position of connecting the fixing portion 11 and the connecting portion 13, and a second stop surface 122 at a position of connecting the stop portion 12 and the connecting portion 13. In this embodiment, the stop portion 12 is a plate, and the stop portion 12 is a distal arc surface 121 opposite to a lateral surface of the second stop surface 122.

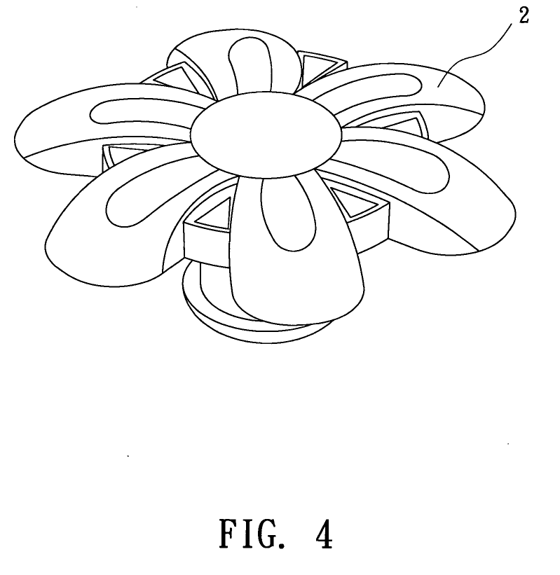

The stylish decorative object 2 has a three-dimensional shape, and the stylish decorative object 2 has a bottom surface 21 fixed to the fixing portion 11 of the connecting member 1. In this embodiment, the stylish decorative object 2 has a shape of a ladybug. Of course, the stylish decorative object 2 can also have other shape such as a strawberry, a flower, a mushroom, and an apple as shown in FIG. 4.

The light emitting device 3 includes a light emitting element 32 that emits light when it is shaken, and the light emitting element 32 of the light emitting device 3 is installed inside the stylish decorative object 2, and the stylish decorative object 2 comes with a specific light transmittance for projecting a light emitted from the light emitting element 32 of the light emitting device 3. In this embodiment, the stylish decorative object 2 includes a sealed space 22, for installing the light emitting device 3, and the light emitting device 3 further comprises a circuit control board 31, and the circuit control board 31 installs the light emitting element 32, and the light emitting element 32 supplies power from at least one battery 33. In this embodiment, the light emitting element 32 is a light emitting diode, and the circuit control board 31 includes the battery 33 and a vibration switch 34, and the light emitting element 32 is activated by the vibration switch 34 to emit light.

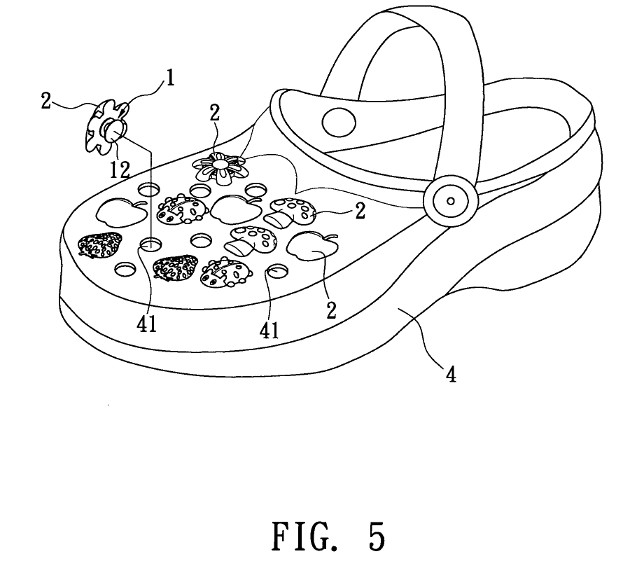

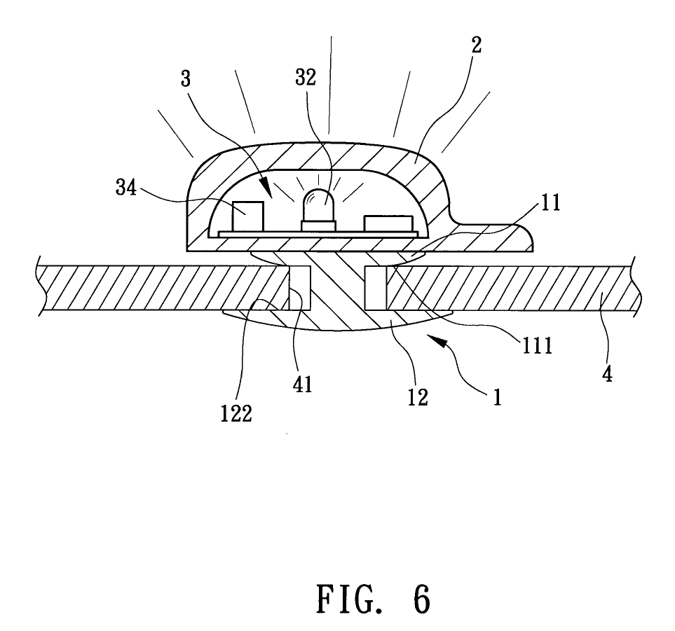

When use, the decorative object is connected to a connected object by using a connecting member 1 as shown in FIGS. 5 and 6. In this embodiment, the connected object is a shoe 4 made of a rubber material, and an upper vamp of the shoe 4 includes a plurality of connecting holes 41, and the stop portion 12 of the connecting member 1 is passed through the connecting hole 41 of the shoe 4 (due to the rubber material of the shoes, the connecting hole can be spread open slightly), such that the first stop surface 111 of the fixing portion 11 and the second stop surface 122 of the stop portion 12 of the connecting member 1 stop both sides of the connecting hole 41 respectively, and the connecting member 1 is fixed onto the shoe 4, and the stylish decorative object 2 is exposed from a surface of the shoe 4 to improve the decoration effect of the shoe 4, and many different shaped stylish decorative object 2 can be prepared, so that users can combine a decorative object of their preference to the shoe 4 to give a better decoration effect. When a user is walking, the light emitting device 3 situated in the stylish decorative object 2 is vibrated, the vibration switch 34 of the light emitting device 3 detects a vibration to start the light emitting element 32 to blink or emit light, so that the decorative object can have a better decoration effect and provide a warning lamp for users to walk at nighttime, so as to enhance the practicability and fun of its use.

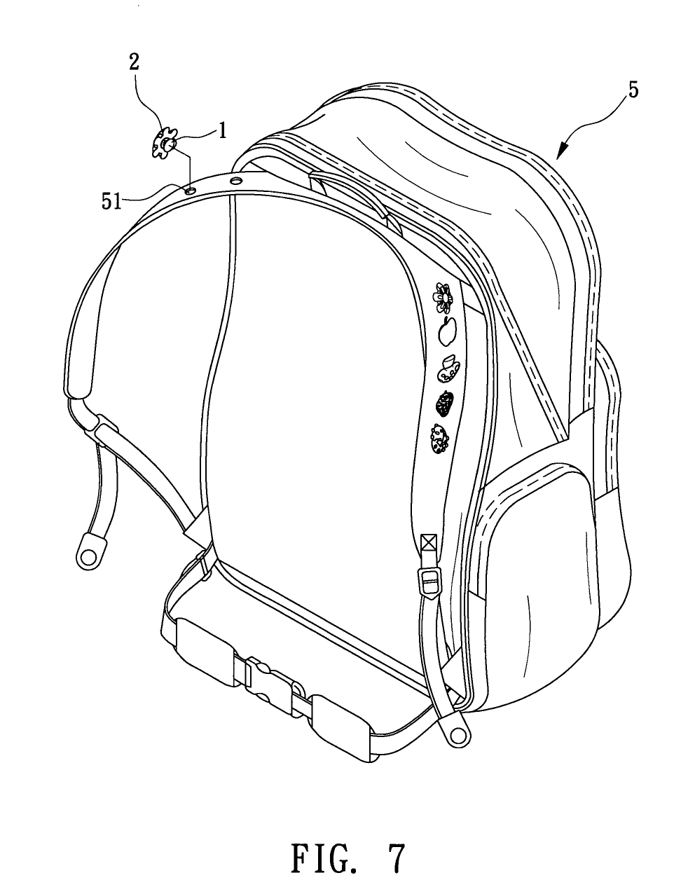

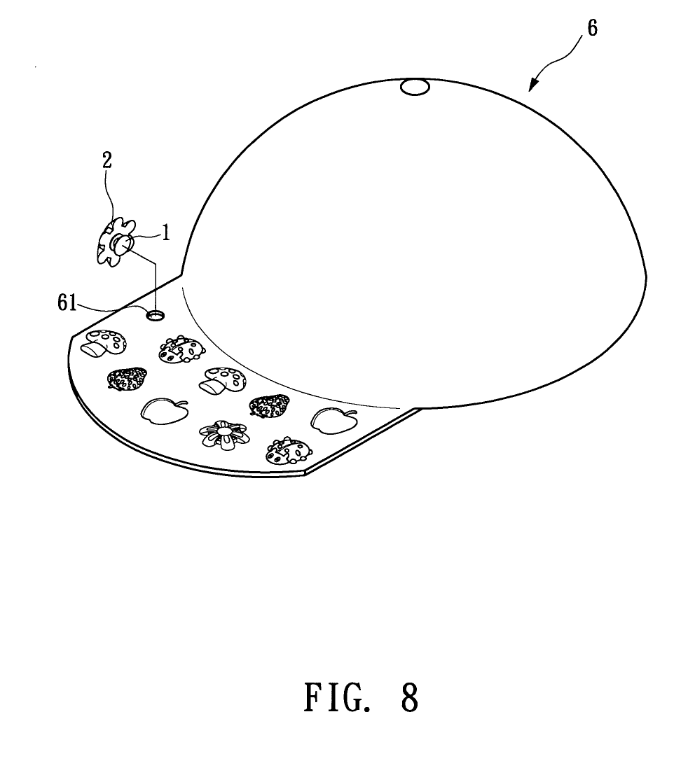

Of course, the connected object is not limited to a shoe, but it can also be a backpack 5 or a hat 6, as shown in FIGS. 7 and 8 respectively. Both of the backpack 5 and the hat 6 have a plurality of connecting holes 51, 61 thereon, and the decorative object can connect the connecting member 1 into the connecting hole 51, 61, so that the stylish decorative object 2 is exposed from a surface of the backpack 5 or the hat 6 to improve the decoration effect, and provides a better practicability for combining to different connected objects, and also emits light through the stylish decorative object 2 by using the light emitting device 3 for providing a warning effect to users who are walking in nighttime.

If it is necessary to remove or replace a decorative object from the connected object, a user simply needs to separate the stop portion of the connecting member from the connecting hole of the connected object to remove the decorative object or replace the decorative object by another stylish decorative object of another shape.

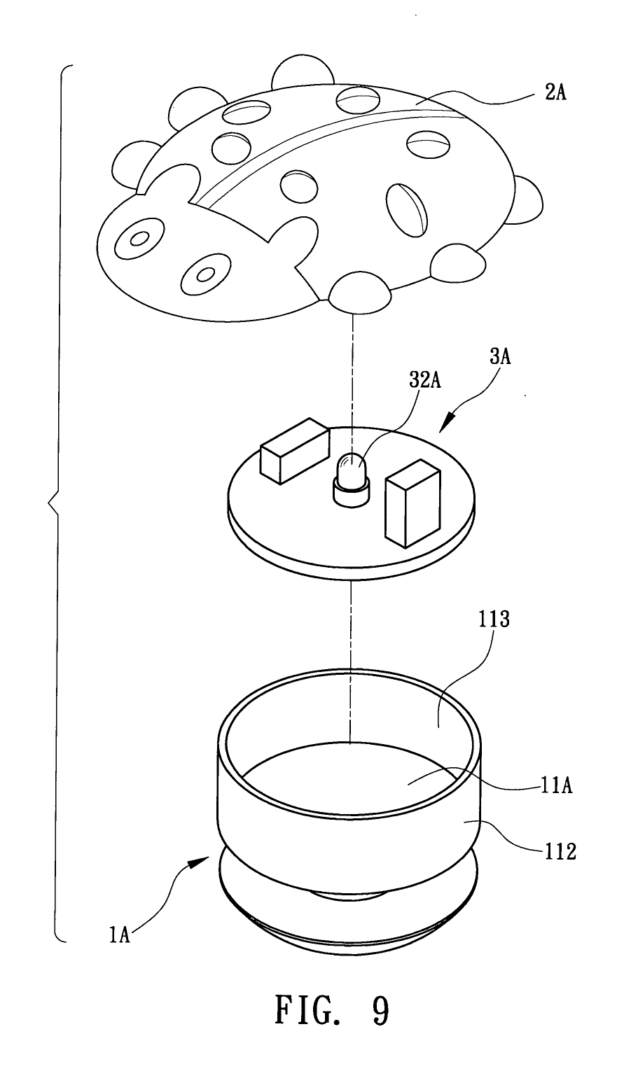

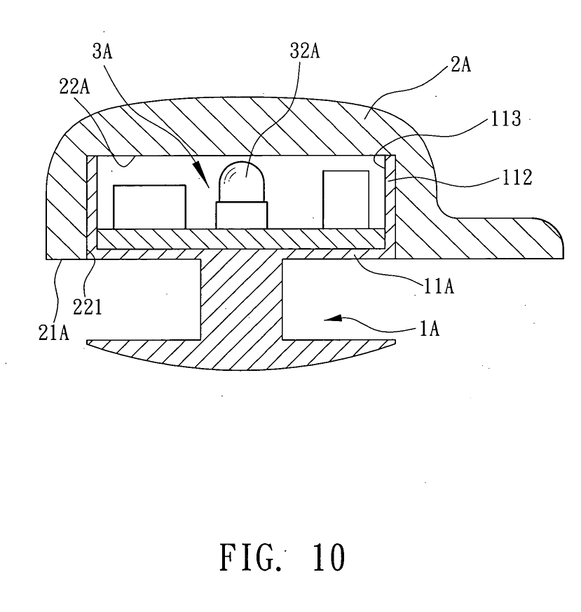

Further, there are many other embodiments of the present invention, and minor modifications are involved. Refer to FIGS. 9 and 10 for a second preferred embodiment of the present invention.

The light emitting device 3A is installed in the connecting member 1A, and the light emitting element 32A of the light emitting device 1A is disposed inside the stylish decorative object. This embodiment is described as follows:

A wall surface 112 is extended upward from the periphery of the fixing portion 11A at an end of the connecting member 1A for forming a groove 113 in the wall surface 112, and the groove 113 is provided for installing the light emitting device 3A.

The stylish decorative object 2A includes an opening 221 in the space 22A and towards the bottom surface 21A for embedding the wall surface 111 of the fixing portion 11A of the connecting member 1A into the space 22A from the opening 221, such that the light emitting device 3A can be installed inside the stylish decorative object 2A.

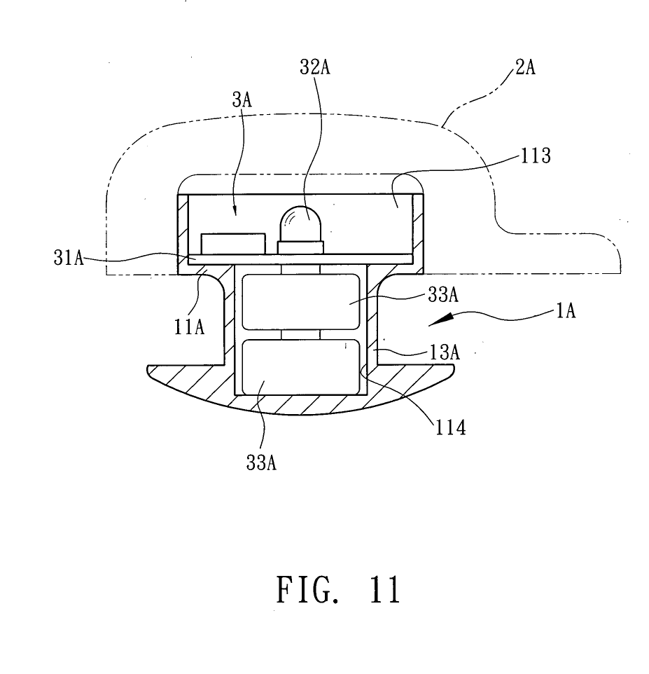

Refer to FIG. 11 for a third preferred embodiment of the present invention.

A chamber 114 is sunken towards the connecting portion 13A and into the bottom of a groove 113 of the fixing portion 11A at an end of the connecting member 1A for installing a circuit control board 31A of the light emitting device 3A in the groove 113, and the chamber 114 contains a battery 33A of the light emitting device 3A.

Due to the material of the stylish decorative object, high-temperature baking and shaping are required. To prevent the light emitting device from being affected or broken down by high temperature, the structure of the second and third preferred embodiments forms the stylish decorative object 2A first, and then fixes fixing portion 11A of the connecting member 1A and the light emitting device 3A inside the stylish decorative object 2A in order to assure that the light emitting device 3A will not fail due to the high temperature, and further improve the yield rate of the finished goods.

In the structure of a third preferred embodiment, a battery 33A of the light emitting device 3A is moved into the chamber 114 for reducing the structure of the fixing portion 11A, and also reducing the volume of the stylish decorative object 2A correspondingly.

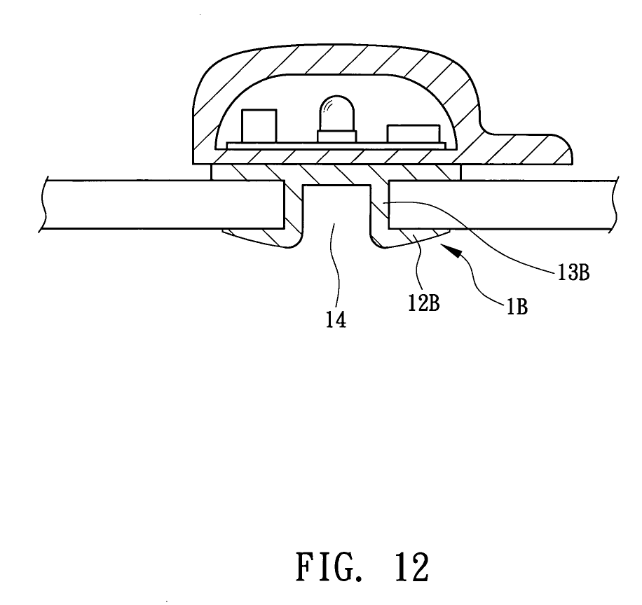

Refer to FIG. 12 for a fourth preferred embodiment of the present invention.

The connecting portion 13B of the connecting member 1B is a hollow pillar, and includes a plurality of equidistant dents 14 disposed along the axial direction of the connecting portion 13B and the stop portion 12B.

Since each stop portion has the dent, therefore each stop portion can be compressed inward when the stop portion is connected to a connecting hole of a shoe, and passed through the connecting hole more easily as well as separating the connecting hole more conveniently to improve the convenience of the installation and removal.

In summation of the description above, the major advantages of the present invention resides on that the structure of the invention can remove the decorative object from the connected object to provide more choices of changing the shape of the decorative object, and the design of the light emitting device not only gives more fun to its use, but also provides a warning lamp for users who walk at nighttime.

1. A decorative object connectable to a connected object, comprising a connecting member coupled to a connected object, a stylish decorative object fixed to an end of the connecting member, and a light emitting device installed in the stylish decorative object, wherein:
the connecting member includes a fixing portion disposed at an end of the connecting member, and a stop portion disposed at another end of the connecting member, and the connecting member includes a connecting portion disposed between the fixing portion and the stop portion, and an external diameter of the connecting portion is smaller than the external diameter of the fixing portion and the stop portion, for forming a first stop surface at a position of connecting the fixing portion and the connecting portion, and a second stop surface at a position of connecting the stop portion and the connecting portion;
wherein the connecting member includes a wall surface extended upward from a periphery of the fixing portion at an end of the connecting member, for forming a cavity in the wall surface, and the cavity is provided for installing the light emitting device, and the stylish decorative object includes a space, and the space includes an opening, for embedding the wall surface of the fixing portion of the connecting member into the space from the opening, and installing the light emitting element of the light emitting device inside the stylish decorative object;
the stylish decorative object has a three-dimensional shape, and the stylish decorative object is fixed to the fixing portion of the connecting member;
the light emitting device includes a light emitting element capable of emitting light after being shaken, and the light emitting element comprises at least one battery for supplying power, and the light emitting element is installed in the stylish decorative object, and the stylish decorative object has a specific light transmittance for projecting a light emitted from the light emitting element of light emitting device;
wherein the light emitting device further includes a circuit control board, and the circuit control board installs the light emitting element, and the circuit control board also installs the battery and a vibration switch, and the battery provides the power supply for the light emitting element, and the light emitting element emits light after activated by the vibration switch.

2-3. (canceled)

4. The decorative object connectable to a connected object as recited in claim 1, wherein the light emitting element of the light emitting device is a light emitting diode.

5-6. (canceled)

7. The decorative object connectable to a connected object as recited in claim 1, wherein the connecting member has a chamber disposed at a bottom of the cavity groove of the fixing portion and sunken towards the connecting portion, for installing the light emitting element of the light emitting device into the cavity, and the chamber is provided for accommodating the battery of the light emitting device.

8. (canceled)

9. The decorative object connectable to a connected object as recited in claim 1, wherein the stylish decorative object has a shape of a ladybug.

10. The decorative object connectable to a connected object as recited in claim 1, wherein the stylish decorative object has a shape of a flower.

11. (canceled)
